(19) United States
(12) Patent Application Publication
(10) Pub. No.: US 2008/0005425 A1
(43) Pub. Date: Jan. 3, 2008

(54) Electronic Card Type Media Storage and Player Device

(75) Inventor: Tamio Saito, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IVI Smart Technologies, Inc., New York, NY (US)

(21) Appl. No.: 11/758,604

(22) Filed: Jun. 5, 2007

Related U.S. Application Data
(60) Provisional application No. 60/811,227, filed on Jun. 5, 2006.

(51) Int. Cl. G06F 13/38

(52) U.S. Cl. 710/62

(57) ABSTRACT

An electronic card includes (a) a card body substrate, (b) a flash memory device embedded in the card body substrate, (c) a microprocessor unit coupled to the flash memory device, and (d) a wireless interface adapted to communicate with a wireless headphone. The electronic card may also includes a battery for providing power to the flash memory, the microprocessor unit, and the wireless interface.

### CROSS-REFERENCE TO RELATED APPLICATIONS

The present disclosure may be related to the following commonly assigned applications/patents:

This application claims priority from co-pending U.S. Provisional Patent Application No. 60/______ filed Jun. 5, 2006 entitled “ELECTRONIC CARD TYPE MEDIA STORAGE AND PLAYER DEVICE” which is hereby incorporated by reference, as if set forth in full in this document, for all purposes.

The respective disclosures of these applications/patents are incorporated herein by reference in their entirety for all purposes.

### FIELD OF THE INVENTION

The present invention relates to media storage and player devices. More particularly, the present invention relates to electronic card-type media storage and player devices.

### BACKGROUND OF THE INVENTION

A conventional USB flash drive is a NAND-type flash memory integrated with a universal serial bus (USB) interface, which is a small, lightweight, removable data storage device. USB flash drives use the USB mass storage standard (USB mass storage device class), which is a set of computing communication protocols defined by the USB Implementers Forum that run on the USB. The standard provides an interface to a variety of storage devices.

USB flash drives are also known by a variety of names, including “(USB) key drives”, “(USB) keys”, “keychain drives”, “pen drives”, “chip sticks”, “data sticks”, “dongles”, “flash (memory) drives”, “thumb drives”, “thumb keys”, “USB drives”, “USB sticks”, and the like. USB flash drives are typically in a size and shape of a pack of gum, but also come in various, sometimes bulky, novelty, or fancy shapes and sizes.

A conventional flash drive typically consists of a small printed circuit board (PCB) enclosed in a plastic or metal casing, and a USB connector which is typically a single male type-A USB connector. The USB connector protrudes from the casing, and is usually covered by a removable cap. Most flash drives have the standard type-A USB connection to be directly connected to a port on a personal computer, and are active only when powered by a USB computer connection. They require no other external power source or battery power source.

The printed circuit board in a typical flash drive includes some simple power circuitry and a small number of surface-mounted integrated circuits (ICs). Typically, one of these IC's provides an interface to the USB port, another drives the on-board memory, and the other is the flash memory. For example, a flash drive includes a USB mass storage controller device, a NAND flash memory chip, and a crystal oscillator. The controller device includes a small RISC microprocessor and a small amount of on-chip ROM and RAM, implementing a USB host controller and interface to the flash memory. The crystal oscillator produces the device's main clock signal (12 MHz) and controls the device's data output through a phase-locked loop.

A typical flash drive may also include jumpers and test pins for testing during the flash drive's manufacturing or loading code into the microprocessor, LEDs indicating data transfer or data reads/writes, a write-protect switch, and a space for a second flash memory chip (for a greater size of the memory).

The size and shape of the casing of a flash drive varies depending on the manufacturer. Some flash drives have a stylized and bulky shell, but those having a slimmer rectangular casing are preferred by many users since they do not obstruct adjacent USB ports or other ports, or USB extension hubs.

Wireless USB (WUSB) is a wireless extension to USB. WUSB is based on ultra wideband wireless technology defined by WiMedia (IEEE 802.15.3a, yet to be accepted), which operates in the range of 3.1-10.6 GHz. WUSB offers bandwidth of 480 Mbit/s at three (3) meters and 110 Mbit/s at ten (10) meters. It should be noted that “WirelessUSB™” by Cypress Semiconductor is a protocol that uses the 2.4 GHz ISM band with a range from 10 meters (at max 1 Mbit/s) to 50 meters (at max 62.5 kbit/s), which is designed for Human Interface Devices (HID), and is not a “Certified Wireless USB” protocol.

### BRIEF SUMMARY OF THE INVENTION

An electronic card includes (a) a card body substrate, (b) a flash memory device embedded in the card body substrate, (c) a microprocessor unit coupled to the flash memory device, and (d) a wireless interface adapted to communicate with a wireless headphone. The electronic card may also include a battery for providing power to the flash memory, the microprocessor unit, and the wireless interface.

The following detailed description together with the accompanying drawings will provide a better understanding of the nature and advantages of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a block diagram schematically illustrating an electronic card in accordance with one embodiment of the present invention.

FIG. 2 is a block diagram schematically illustrating an electronic card in accordance with one embodiment of the present invention.

FIGS. 3A and 3B are diagrams schematically illustrating an electronic card implementing a card-type PDA in accordance with one embodiment of the present invention.

FIG. 4 is a drawing illustrating an electronic card with an ISO connector interface and a tri-color LED in accordance with one embodiment of the present invention.

FIG. 5 is a drawing illustrating an electronic card with an external battery and an adapter adapted to allow connection to the card through a USB cable or headphone cable in accordance with one embodiment of the present invention.

FIG. 6 is a drawing illustrating an electronic card with an external battery and an adapter adapted to receive an external battery in accordance with one embodiment of the present invention.

FIG. 7 is a drawing illustrating an electronic card with an embedded battery in accordance with one embodiment of the present invention.

FIG. 8 is a drawing illustrating an electronic card with an external battery and a wireless interface adapted to communicate with a wireless headphone in accordance with one embodiment of the present invention.

FIG. 9 is a drawing illustrating an electronic card connected to an external speaker system through its ISO connector interface and/or a USB connector interface in accordance with one embodiment of the present invention.

FIG. 10 is a drawing illustrating an electronic card as a file storage device in accordance with one embodiment of the present invention.

FIG. 11 is a drawing illustrating an electronic card with a reader/charger plate in accordance with one embodiment of the present invention.

FIG. 12 is a drawing illustrating an electronic card with a charge-coupled device (CCD) and a complex lens in accordance with one embodiment of the present invention.

FIG. 13 is a drawing illustrating an electronic card with a polymer color display in accordance with one embodiment of the present invention.

FIG. 14 is a drawing illustrating an electronic card as a personal digital assistant (PDA) in accordance with one embodiment of the present invention.

FIG. 15 is a drawing illustrating an electronic card as a flash mass storage device adapted to store MP3/4 data (music), MPEG data (video), PDF data (files), and the like in accordance with one embodiment of the present invention.

FIG. 16 is a drawing illustrating an electronic card with a fingerprint sensor in accordance with one embodiment of the present invention.

FIG. 17 is a block diagram schematically illustrating an electronic card in accordance with one embodiment of the present invention.

### DETAILED DESCRIPTION OF THE INVENTION

Embodiments of the present invention are described herein in the context of an electronic card type media storage and player device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts. The attached Appendix contains additional information, which is hereby incorporated by reference into the disclosure of the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

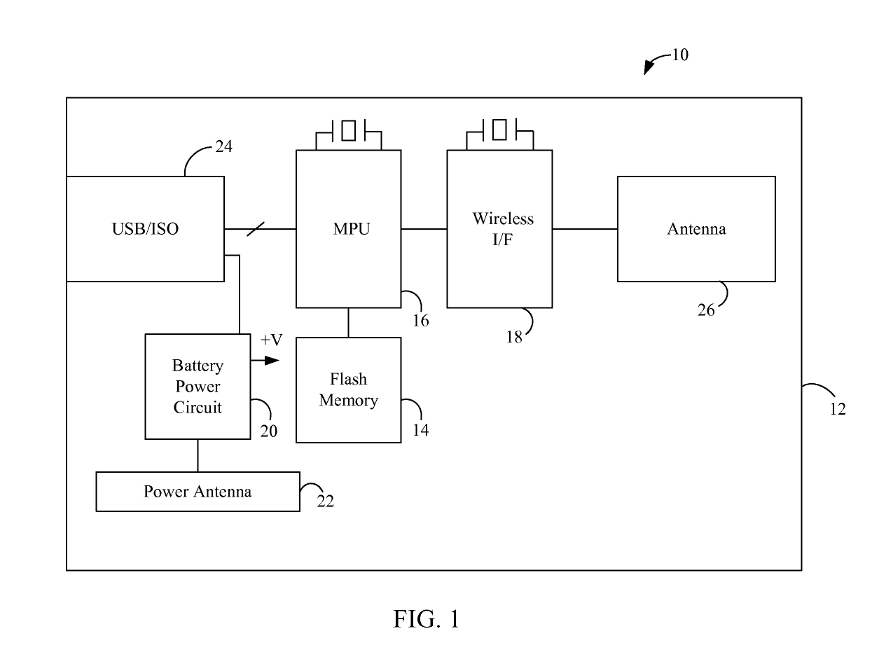

FIG. 1 schematically illustrates an electronic card 10 in accordance with one embodiment of the present invention. The electronic card includes a card body substrate 12, a flash memory device 14, embedded in the card body substrate, a microprocessor unit (MPU) 16 coupled to the flash memory device 14, and a wireless interface 18 adapted to communicate with a wireless headphone. The flash memory device 14 may be a flash mass storage device adapted to store MP3/4 data (music), MPEG data (video), PDF data (files), and the like. The card 10 may have a form substantially the same as a conventional ISO card with a thickness of about 0.78 to 1.90 mm. This ISO card form factor is very unique to the flash memory device in accordance with the present invention.

The electronic card 10 may further include a battery 20 for providing power to the flash memory device 14, the microprocessor unit 16, and the wireless interface 18, and other components on the card 10. In addition, the card 10 may include an ISO connector interface and/or a USB connector interface 22. The battery 20 is preferably thin and may be embedded in the card body substrate 12. The battery 20 may be rechargeable, and may receive power from the ISO/USB connector interface 22, if such connector interface is provided. The electronic card 10 may further include a power antenna 24 coupled to the battery such that the battery is recharged wirelessly. The battery 20 may be part of a power circuit which includes a battery and a regulator.

The wireless interface 18 may be a wireless USB interface based on ultra wideband wireless technology (IEEE 802.13.3a) or Bluetooth (IEEE 802.15.1). Such wireless communications may also utilize Sub Band Communications (SBC) in order to transmit data without interruption. The wireless interface 18 may include an encoder/decoder circuit (not shown in FIG. 1) and a signal antenna 26. The type of the encoder/decoder depends on the data format stored in the flash memory device 14. The antenna 26 may be stereo antennas. The antenna 26 and the wireless interface 18 may be used to download and/or upload data wirelessly. The received data is stored on the flash memory 14.

In accordance with one embodiment of the present invention, the card 10 may include an adapter adapted to receive an external battery. Such an adapter may be a USB connector. Furthermore, in accordance with one embodiment of the present invention, the card 10 may include an adapter adapted to receive an external speaker system.

The card 10 may be used with a card reader or charger. A connector type card reader/charger may use the ISO/USB connections to read/write and/or charge the card. A wireless type card reader/charger may be a plate receiving the cared thereon, and includes power/signal antennas. [003

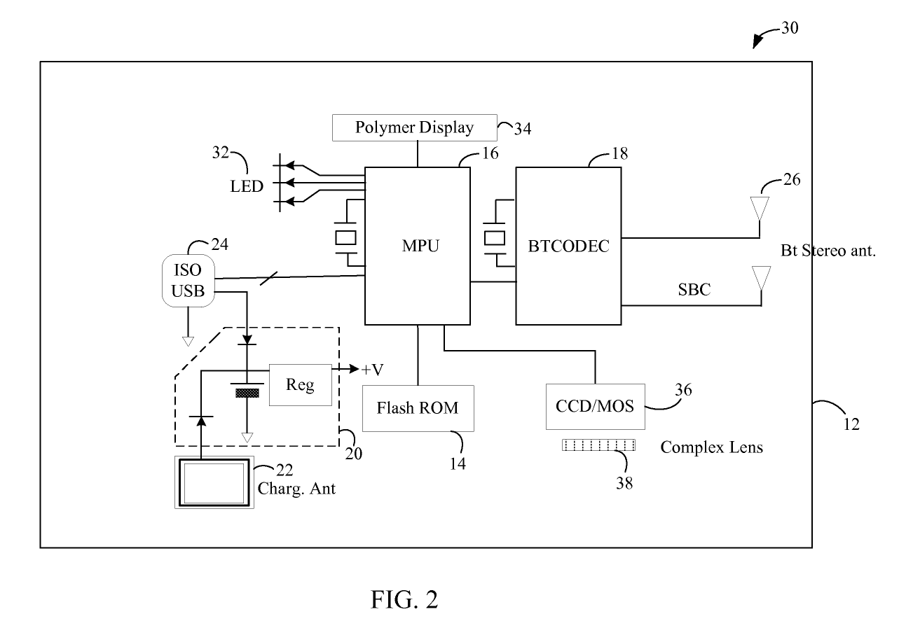

FIG. 2 schematically illustrates an electronic card 30 in accordance with one embodiment of the present invention. The card 30 may further include, in addition to the components of the card 10 as described above, an LED indicator 32 provided on the surface of the card body substrate 12, which indicates the status of operation of the card (such as playing music, transferring files, charging, and the like). The LED indicator 32 may be a tri-color indicator or may include a plurality of such indicators.

In accordance with one embodiment of the present invention, the card 30 may also include a polymer color display 34. Since the card 30 has a shape similar to that of an ISO card, there is a sufficient area to provide such a display. The display 34 may be used to display the file contained in the flash memory 14, for example, to watch movies, videos, or still images.

In accordance with one embodiment of the present invention, the card 30 may include a charge-coupled device (CCD) 36 and a complex lens 38 to provide a digital camera function.

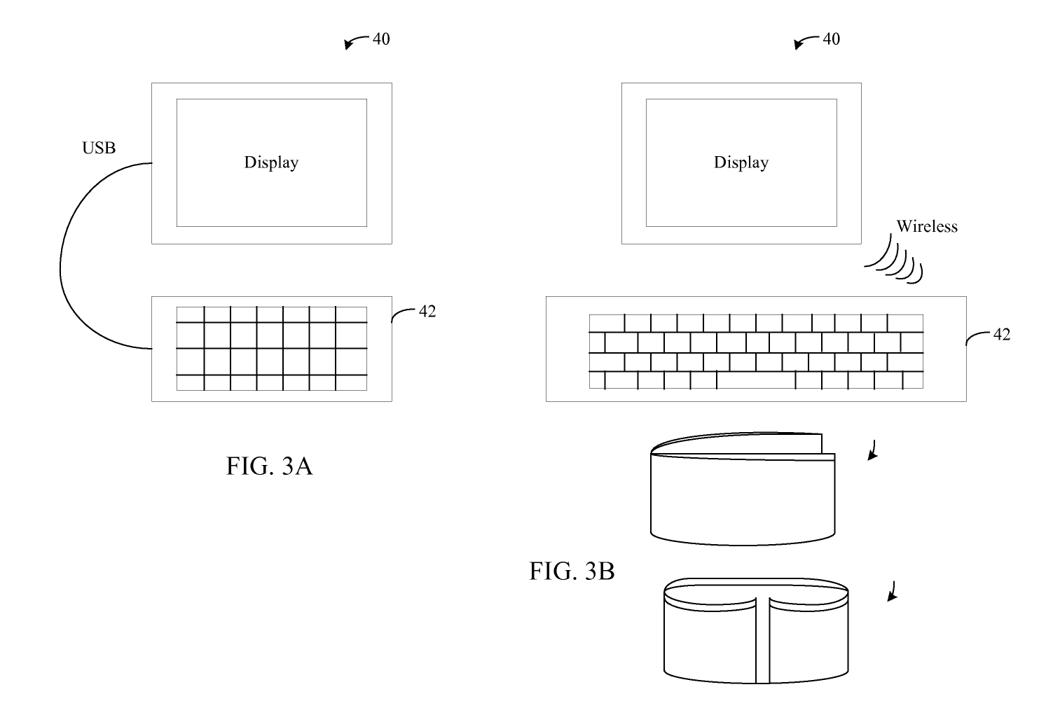

FIGS. 3A and 3B schematically illustrates an electronic card 40 in accordance with one embodiment of the present invention. The electronic card 40 may be used as a card-type personal digital assistant (PDA). The structure of the electronic card 40 is similar to that of card 30 as described above. An external flexible keyboard 42 may be connected via the USB connector 24 or via the wireless interface 18 to input data and/or commands. Such an external keyboard 42 may be substantially the same size as the electronic card (FIG. 3A), or may be folded into substantially the same size as the electronic card 40 (FIG. 3B). Since the electronic card 40 has the size substantially the same as an ISO card, it is convenient to carry with, and also the external keyboard provides an easy input device.

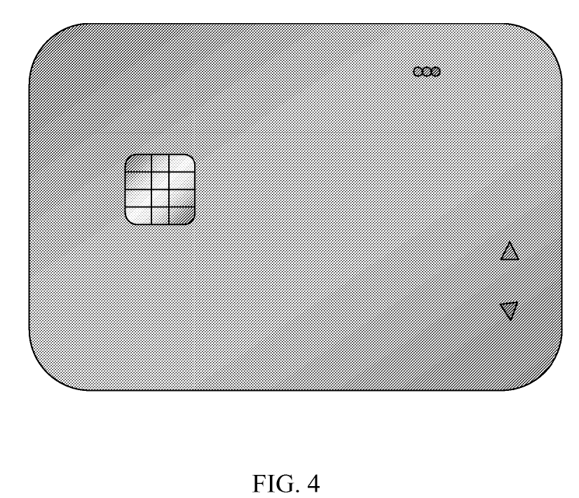

FIG. 4 is a drawing illustrating an electronic card with an ISO connector interface, a tri-color LED, and a scroll switch in accordance with one embodiment of the present invention. The scroll switch may be used as one form of input from the user. This embodiment may include:
MP3/MP4 Decoder
Flash Rom Mass Storage
Storage Management
USB Interface
Thin B Tri color LED
Blue tooth to headphone
Thin Battery
(UWB:Ultra Wide Band)
Scroll Switch

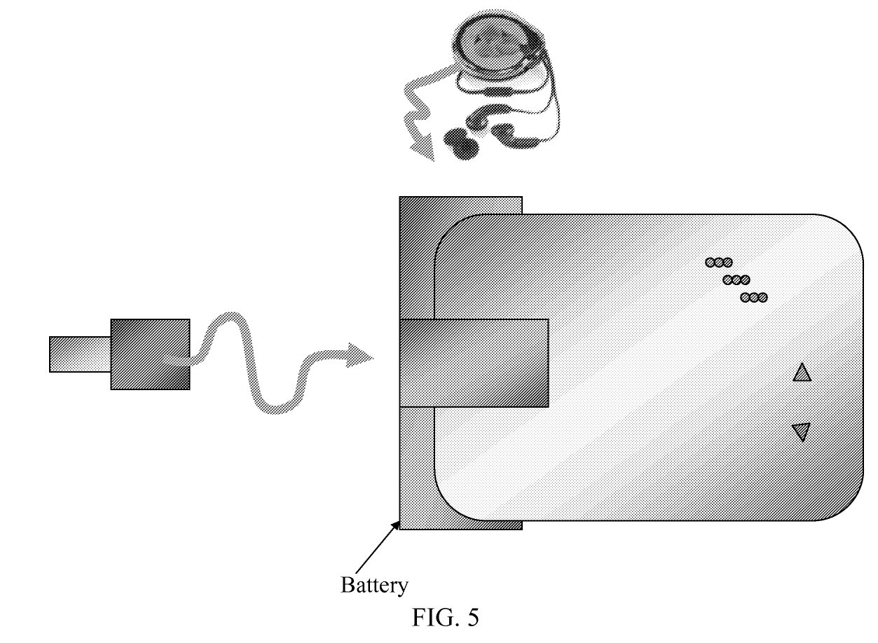

FIG. 5 is a drawing illustrating an electronic card with an external battery and an adapter adapted to allow connection to the card through a USB cable or headphone cable in accordance with one embodiment of the present invention. The adapter may allow connection through a standard USB cable, a mini-USB cable, or the like. The adapter may allow connection through a standard miniature TRS connector, a standard subminiature TRS connector, or the like. The adapter may allow connection to an external battery.

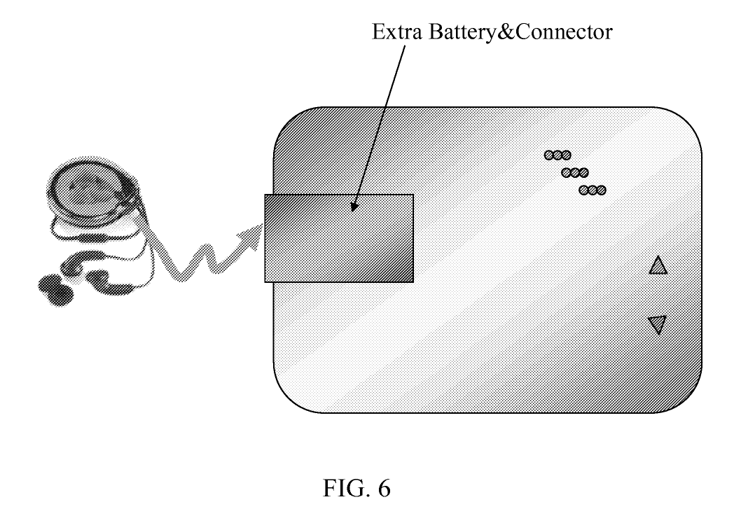

FIG. 6 is a drawing illustrating an electronic card with an external battery and an adapter adapted to receive an external battery in accordance with one embodiment of the present invention.

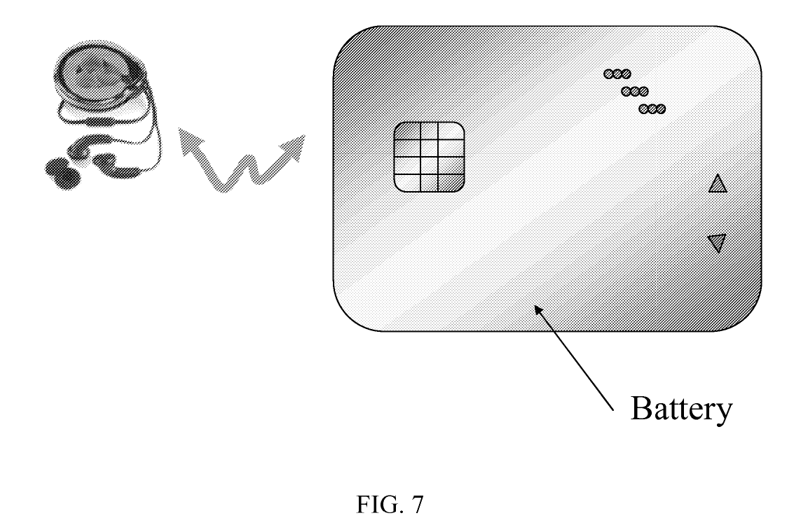

FIG. 7 is a drawing illustrating an electronic card with an embedded battery in accordance with one embodiment of the present invention.

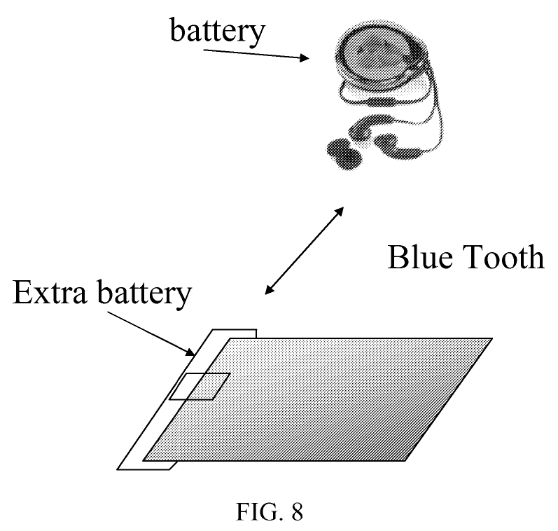

FIG. 8 is a drawing illustrating an electronic card with an external battery and a wireless interface adapted to communicate with a wireless headphone in accordance with one embodiment of the present invention. The communication may utilize Bluetooth (Ultra Width Band 640 Mbps) and/or SBC (Sub Band Communications: none-interrupt)

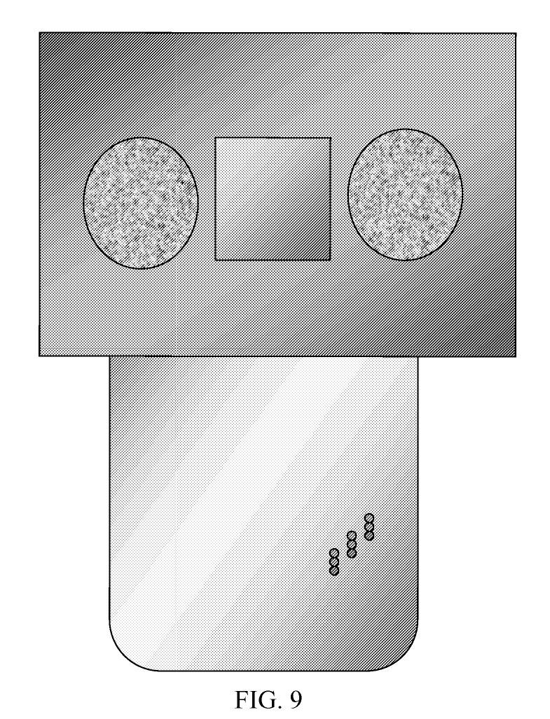

FIG. 9 is a drawing illustrating an electronic card connected to an external speaker system through its ISO connector interface and/or a USB connector interface in accordance with one embodiment of the present invention.

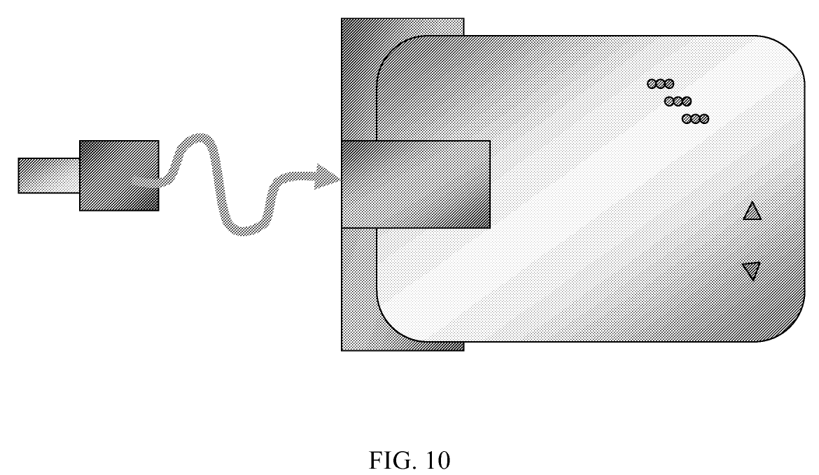

FIG. 10 is a drawing illustrating an electronic card as a file storage device in accordance with one embodiment of the present invention. This embodiment may include:
Crypto Engine
Program Management
MP3/MP4
Flash Rom Mass Storage
Storage Management
USB Interface
Thin Battery
Tri color LED
Blue tooth
Scroll Switch

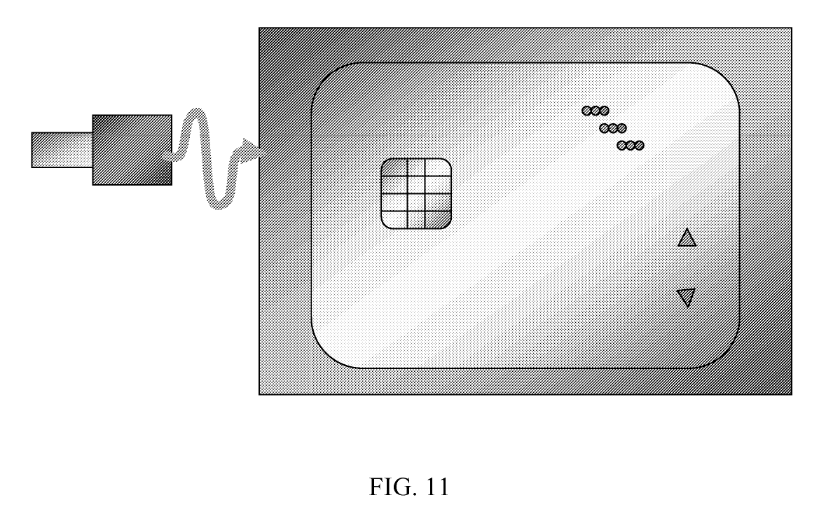

FIG. 11 is a drawing illustrating an electronic card with a reader/charger plate in accordance with one embodiment of the present invention. This embodiment may include:
Wireless Charging
Wireless Downloading
MP3/MP4
Flash Rom Mass Storage
Storage Management
USB Interface
Thin Battery
Tri color LED
Blue tooth
Scroll Switch

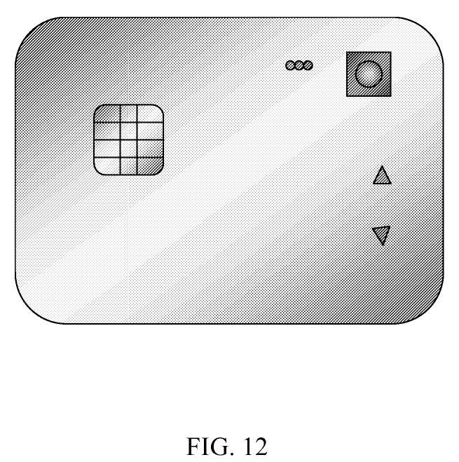

FIG. 12 is a drawing illustrating an electronic card with a charge-coupled device (CCD) and a complex lens in accordance with one embodiment of the present invention. This embodiment may include:
Thin lens (Complex Lens)
Image Processing
WarpWave Compression
Flash Rom Mass Storage
Wireless Charging
Wireless Downloading
MP3/MP4
Storage Management
USB Interface
Thin Battery
Tri color LED
Blue tooth
Scroll Switch

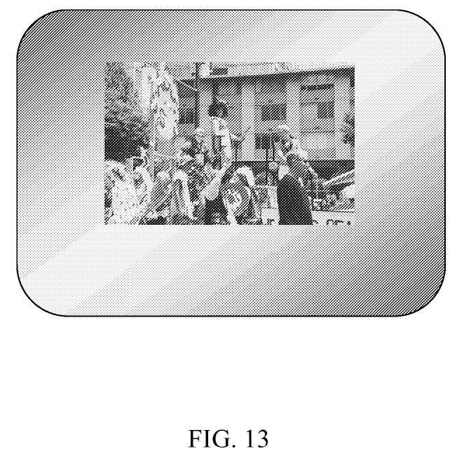

FIG. 13 is a drawing illustrating an electronic card with a polymer color display in accordance with one embodiment of the present invention. This embodiment may include:
Color Film LCD
MPEG IV
WarpWave Compression(further)
Flash Rom Mass Storage
Thin lens (Complex Lens)
Wireless Charging
Wireless Downloading
MP3/MP4
Storage Management
USB Interface
Thin Battery
Tri color LED
Blue tooth
Scroll Switch

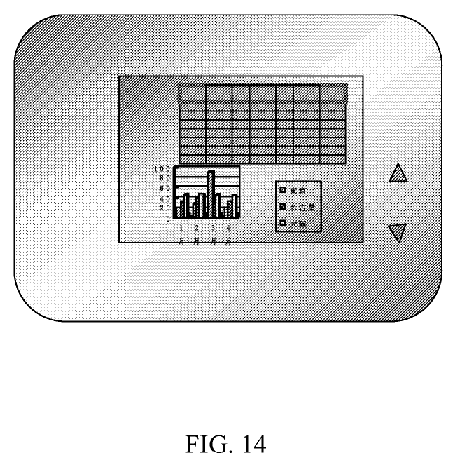

FIG. 14 is a drawing illustrating an electronic card as a personal digital assistant (PDA) in accordance with one embodiment of the present invention. This embodiment may include:
WarpWave OS
Color Film LCD
Thin lens (Complex Lens)
Wireless Charging
Wireless Downloading
MP3/MP4
Flash Rom Mass Storage
Storage Management
USB Interface
Thin Battery
Tri color LED
Blue tooth
Scroll Switch

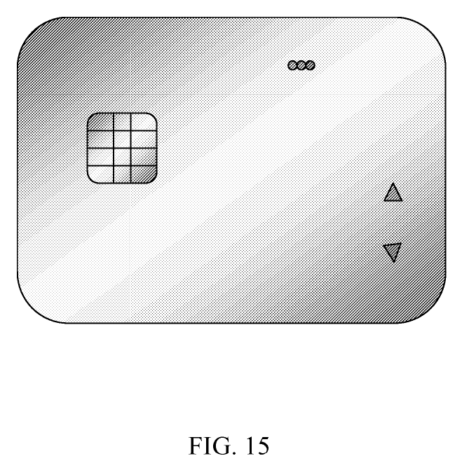

FIG. 15 is a drawing illustrating an electronic card as a flash mass storage device adapted to store MP3/4 data (music), MPEG data (video), PDF data (files), and the like in accordance with one embodiment of the present invention. This embodiment may include:
Pdf manager
WarpWave Compression(pdf)
WarpWave OS
Storage Management
Flash Rom Mass Storage
USB Interface
Tri color LED

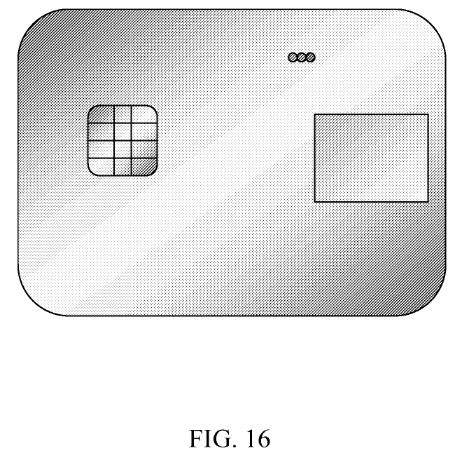

FIG. 16 is a drawing illustrating an electronic card with a fingerprint sensor in accordance with one embodiment of the present invention. The fingerprint sensor may be used as a security mechanism to authenticate users and protect the contents and use of the electronic card.

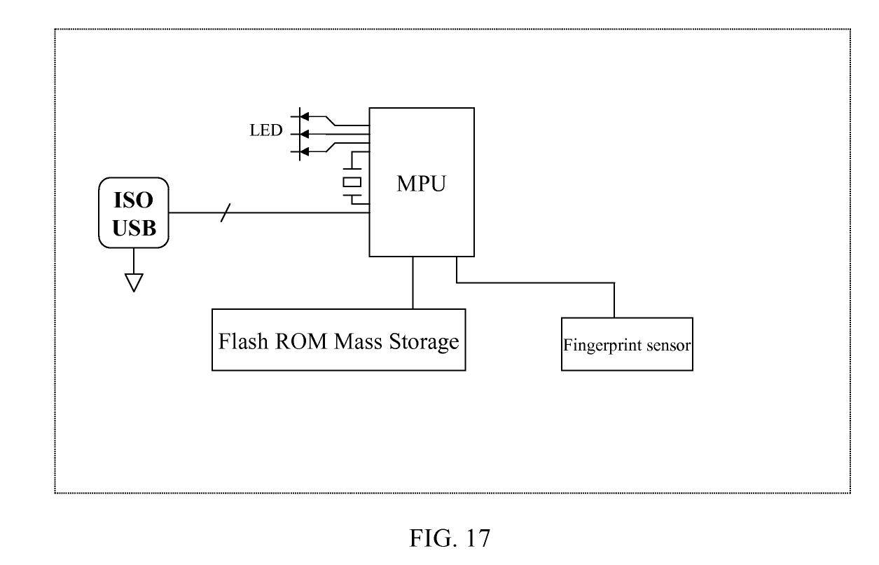

FIG. 17 is a block diagram schematically illustrating an electronic card in accordance with one embodiment of the present invention. The MPU may receive fingerprint data from the fingerprint sensor in order to authenticate users.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. An electronic card comprising:
a card body substrate;
a flash memory device embedded in the card body substrate;
a microprocessor unit coupled to the flash memory device; and
a wireless interface adapted to communicate with a wireless headphone.

2. The electronic card of claim 1, further comprising a battery for providing power to the flash memory, the microprocessor unit, and the wireless interface.

3. The electronic card of claim 2, wherein the battery is embedded in the card body substrate.

4. The electronic card of claim 2, wherein the battery is rechargeable and the electronic card further comprising a power antenna coupled to the battery.

5. The electronic card of claim 2, further comprising an adapter adapted to receive an external battery.

6. The electronic card of claim 5, wherein the adapter is an universal serial bus (USB) connector.

7. The electronic card of claim 1, further comprising:
a power circuit for providing power to the flash memory, the microprocessor unit, and
the wireless interface; and a power antenna coupled to the power circuit.

8. The electronic card of claim 1, further comprising an adapter adapted to receive an external speaker system.

9. The electronic card of claim 1, further comprising at least one of an ISO connector interface and a USB connector interface.

10. The electronic card of claim 1, wherein the wireless interface includes a wireless USB interface.

11. The electronic card of claim 11, wherein the wireless USB interface is based on ultra wideband wireless technology (IEEE 802.13.3a).

12. The electronic card of claim 1, wherein the wireless USB interface is based on Bluetooth (IEEE 802.15.1).

13. The electronic card of claim 1, further comprising an LED indicator.
